(19) United States
(12) Patent Application Publication
(10) Pub. No.: US 2011/0241829 A1
(43) Pub. Date: Oct. 6, 2011

(54) REMOTE KEYLESS ENTRY DEVICE

(76) Inventor: JACQUELINE BALDWIN, Little Rock, AR (US)

(21) Appl. No.: 12/750,368

(22) Filed: Mar. 30, 2010

(51) Int. Cl. G06F 7/04

(52) U.S. Cl. 340/5.54

(57) ABSTRACT

A remote keyless entry device for keyless entry into a vehicle comprising: a first side, where said first side includes a numerical keypad; a second side, where said second side includes a plurality of activation buttons; a memory device, where said memory device stores a numerical code; and a means to activate the plurality of activation buttons upon entry of the numerical code. The numerical keypad includes numerical keys, which may range from 0 to 9. The numerical code may include either a four-digit number or six-digit number. The remote keyless entry device according to claim 1, where said plurality of activation buttons include a lock button, an unlock button, an alarm button, a light button and a truck release button.

### BACKGROUND OF THE INVENTION

1. Field of Invention

The present invention relates to a remote keyless entry device for use with a motor vehicle.

2. Description of Related Art

Remote keyless systems are well-known in the prior art and includes systems that are designed to remotely permit or deny access to premises or motor vehicles. Remote keyless systems perform many functions that eliminate the necessity a physical key such as the ability to unlock and lock doors or to gain access to the trunk area of the vehicle. The functions are provided on a small remote that may be attached to a physical key for the vehicle. The functions are initiated by pressing of one of the activation buttons provided on the small remote. The keyless systems operate by broadcasting radio waves that are received by a control system within a vehicle that activates the various functions associated with the remote device.

Remote entry devices are used on most vehicles sold in the marketplace and very useful to many users to avoid using a physical key. One drawback to the wide use of remote entry devices is the ability for a car thief to gain access to the vehicle. Upon possession of such a remote entry device, a thief merely needs to activate or deactivate the various functions to gain access to the vehicle. Many times such a thief may be accomplished without actual specific knowledge of the vehicle, the thief may merely be within the vicinity of the vehicle and begin depressing the various functions on the remote to pinpoint the vehicle and then gain access thereto to steal it. It would therefore be advantageous to have a device that may control the use of the remote entry device and deter or reduce the risks of possible auto theft upon possession of the remote keyless entry device.

### SUMMARY OF THE INVENTION

The present invention relates to a remote keyless entry device for keyless entry into a vehicle comprising: a first side, where said first side includes a numerical keypad; a second side, where said second side includes a plurality of activation buttons; a memory device, where said memory device stores a numerical code; and a means to activate the plurality of activation buttons upon entry of the numerical code. The numerical keypad includes numerical keys, which may range from 0 to 9. The numerical code may include either a four-digit number or six-digit number. The remote keyless entry device according to claim 1, where said plurality of activation buttons include a lock button, an unlock button, an alarm button, a light button and a truck release button.

### BRIEF DESCRIPTION OF DRAWINGS

FIG. 1 depicts a remote keyless entry device according to the present invention.

FIG. 2 depicts an opposing or opposite side of the remote keyless entry device according to the present invention.

### DETAILED DESCRIPTION

The present invention relates to a remote keyless entry device that includes additional security functions that limit the use of the entry device to gain access to a vehicle. The remote keyless entry device according to the present invention includes a numerical keypad that allows the programming of a specific access code in order to gain access to the functions related to the entry device. The remote keyless entry device according to the present invention includes the known or commonly used functions such as locking, unlocking and accessing the truck of the vehicle but also provides a numerical key code that must be entered prior to the entry device being operative.

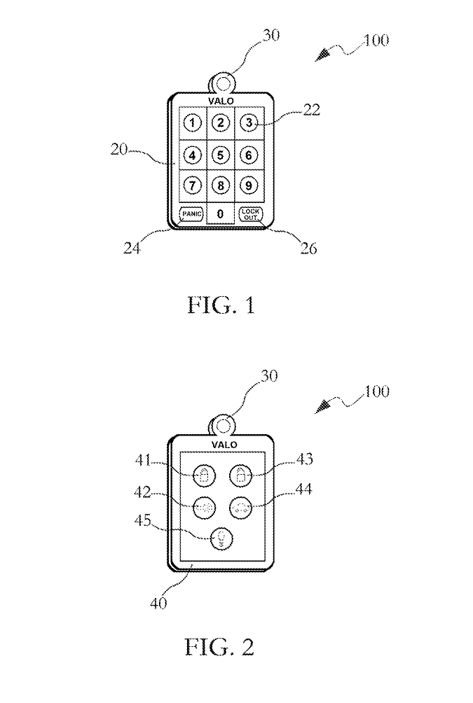

FIG. 1 depicts a remote keyless entry device 100 according to the present invention. The remote keyless device 100 includes a numerical keypad 20 that is provided on a first side of the keyless device 100. The numerical keypad 20 includes numerical keys 22 which range from 0 to 9. This numerical keypad 20 provides a means to lock and secure the functions related to the entry device, and requires the user to enter and set a numerical code that enables the functionality of the device 100. In addition to the numerical keypad 20, a panic button 24 and a lockout button 26 are provided on the first side of this entry device 100. The panic button 24 provides a means for the user to activate an alarm that may deter a thief from committing an assault or other crimes against the user thereof. A lockout button 26 is also provided to completely lock out the vehicle and to prevent entry therein unless the key code is provided on the numerical keypad 20.

FIG. 2 depicts a second side of the entry device 100 according to the present invention. The functions provided on the second side of the entry device 100 are common functions that are associated with a remote keyless device. In particular, a lock button 41 and an unlock button 43 are provided. An alarm button 42, a light button 45 and a truck release button 44 are also provided on the keypad 40 on the second side of the entry device 100. The entry device 100 also includes an eyelet 30 that allows the attachment of the entry device to a key ring for convenient use by the user thereof.

The remote keyless entry device 100 according to present invention provides an additional security feature with respect to the numerical keypad provided on the first side thereof. Use of this numerical keypad provides a built-in security system that prevents the unauthorized use of the entry device. The entry device requires the input of a four to six-digit code on the keypad and therefore prevents the unauthorized access and use of the entry device. Because the entry device requires the input of the code, should a thief obtain the entry device he or she would not be able to determine the vehicle that the device is to be used on without knowledge of the entry code. The entry device may be compatible and used on a variety of vehicles and therefore easily interchanged for a manufacturer entry device provided. The instant invention has been shown and described in what it considers to be the most practical and preferred embodiments. It is recognized, however, that departures may be made there from within the scope of the invention and that obvious modifications will occur to a person skilled in the art.

What is claimed is:

1. A remote keyless entry device for keyless entry into a vehicle comprising:
a. a first side, where said first side includes a numerical keypad;
b. a second side, where said second side includes a plurality of activation buttons;
c. a memory device, where said memory device stores a numerical code; and
d. a means to activate the plurality of activation buttons upon entry of the numerical code.

2. The remote keyless entry device according to claim 1, where the numerical keypad includes numerical keys which range from 0 to 9.

3. The remote keyless entry device according to claim 1, where said numerical code includes at least one of a four digit number and six digit number.

4. The remote keyless entry device according to claim 1, where said plurality of activation buttons include a lock button, an unlock button, an alarm button, a light button and a truck release button.
